(19) United States
(12) Patent Application Publication
(10) Pub. No.: US 2007/0126669 A1
(43) Pub. Date: Jun. 7, 2007

(54) Image display device

(75) Inventors: Takeshi Seto, Chofu-shi (JP); Takashi Takeda, Suwa-shi (JP); Hiroshi Hasegawa, Chino-shi (JP)

Correspondence Address: ADVANTEDGE LAW GROUP, LLC, 1928 E. COBBLESTONE RD., SUITE 100, SPRINGVILLE, UT, 84663, US

(73) Assignee: Seiko Epson Corporation, Tokyo (JP)

(21) Appl. No.: 11/605,865

(22) Filed: Nov. 29, 2006

(30) Foreign Application Priority Data
Dec. 2, 2005 (JP) 2005-348954

(51) Int. Cl. G09G 3/30

(52) U.S. Cl. 345/76

(57) ABSTRACT

An image display device having a plurality of selfluminous pixels, for displaying an image by selectively making the pixels luminous is disclosed. The image display device includes: the pixels each divided into a plurality of small light-emitting sections; an ejection-direction selecting section that deflects the light emitted from the small light-emitting sections at predetermined angles according to the position of the small light-emitting sections in the pixel; and controller that selectively makes only small light-emitting sections that emit light that can reach the viewer luminous on the basis of viewer-position information indicative of the position of the viewer.

### BACKGROUND

1. Technical Field

The present invention relates to an image display device.

2. Related Art

Known image display devices include selfluminous displays which have a plurality of selfluminous pixels and which displays images by selectively causing the pixels to emit light. Examples of such selfluminous displays include cathode ray tubes, plasma displays, organic electroluminescence (EL) displays.

Such selfluminous displays disperse the light emitted from the pixels to a wide range to obtain a wide viewing angle (refer to JP-A-5-299022).

Selfluminous displays have increased in size with the upsizing of displays, posing the problem of increasing power consumption of the selfluminous displays.

On the other hand, since the light emitted from the pixels is dispersed in a wide range, merely a part of the emitted light of each pixel reaches viewer's eyes. Particularly, when not many viewers view the selfluminous displays, most of the emitted light reaches positions other than viewers' eyes.

Thus, the known selfluminous displays emit useless light, which may particularly cause an increase in power consumption.

### SUMMARY

An advantage of some aspect of the invention is that the power consumption of selfluminous displays can be decreased.

According to a first aspect of the invention, there is provided an image display device having a plurality of selfluminous pixels, for displaying an image by selectively making the pixels luminous. The image display device includes: the pixels each divided into a plurality of small light-emitting sections; an ejection-direction selecting section that ejects (deflects) the light emitted from the small light-emitting sections at predetermined angles according to the position of the small light-emitting sections in the pixel; and controller that selectively makes only small light-emitting sections that emit light that can reach the viewer luminous on the basis of viewer-position information indicative of the position of the viewer.

The image display device with this structure is constructed such that each pixel is divided into a plurality of small light-emitting sections, and the lights from the small light-emitting sections are directed at specified angles according to the position of the small light-emitting sections in the pixel. The position of the viewer is detected, and only small light-emitting sections that can surely emit light to the viewer are made luminous selectively.

In other words, the image display device according to an aspect of the invention eliminates the need for emitting useless light as in the known image display device. This arrangement can greatly reduce the light emission of the entire system in comparison with the known image display device. Therefore, the image display device according to an aspect of the invention can reduce the power consumption of the selfluminous display.

According to a second aspect of the invention, there is provided an image display device having a viewer-position sensor that acquires the viewer-position information.

This arrangement facilitates acquiring viewer-position information automatically, thus enabling the position of the viewer to be detected.

In the image display device according to an aspect of the invention, it is preferable that the plurality of small light-emitting sections be divided into a plurality of groups which can emit the light in different colors; and the luminescent light of any one of the small light-emitting sections of each group can reach the viewer who is present in a predetermined position.

This arrangement enables luminescent lights of all colors to reach the viewer who is present in any position.

For example, when the plurality of small light-emitting sections are divided into a red group that emits red light, a green group that emits green light, and a blue group that emits blue light, all the red light, green light, and blue light can reach the viewer who is present in any position. This arrangement allows the viewer to be provided with a full color image even if the viewer is present in any position.

In the image display device according to an aspect of the invention, it is preferable that the groups each have at least five small light-emitting sections.

This arrangement can obviously decrease the light emission of one pixel of the image display device in comparison with that of the known image display device, thus reducing the power consumption of selfluminous displays more efficiently.

In the image display device according to an aspect of the invention, it is preferable that the plurality of groups be arranged in the vertical direction in the pixel.

The plurality of groups may be arranged in the horizontal direction in the pixel.

In the image display device according to an aspect of the invention, it is preferable that the difference between the luminance in the case where the luminescent lights of both adjacent small light-emitting sections in the same group reach the viewer who is in a predetermined place and the luminance in the case where the luminescent light of any one of adjacent small light-emitting sections in the same group reaches the viewer who is in a predetermined place be set within 50 percent.

When the viewer changes in position during viewing, the image display device changes from a state in which the lights from both of adjacent light-emitting sections in the same group can reach the viewer (both small light-emitting sections emit light) to a state in which the light from one of the adjacent small light-emitting sections in the same group can reach the viewer (only one light-emitting section emit light), and vice versa. In this case, the luminance of light that reaches the viewer will be changed. Thus, by limiting the difference in luminance therebetween within 50 percent, unpleasantness of the viewer due to changes in luminance can be prevented.

In the image display device according to an aspect of the invention, it is preferable that at least part of the small light-emitting sections that can emit light to the viewer who is present in a predetermined position be arranged along the same straight line.

The small light-emitting section that emits light to the viewer who is present in a specified position is always the same. This arrangement allows the small light-emitting sections arranged in the same straight line to be controlled at the same time with the same line, thus simplifying the control system.

In the image display device according to an aspect of the invention, it is preferable that the ejection-direction selecting section ejects (deflects) the light emitted from the small light-emitting section closer to the central axis of the display surface as the emission-direction selecting section is located closer to the end of the image display surface.

In the image display device of the aspects of the invention, the viewable range is a range that the light from all the pixels can reach. Specifically, even if the light from the pixel at the end of the display surface can reach outside the range that the light from the pixel in the center of the display surface reaches, so that the light comes to waste. Accordingly, the arrangement allows the light from the small light-emitting sections at the end of the display surface to be efficiently concentrated within the range that the light from the pixel in the center of the display surface reaches, allowing covering of the viewable range without waste.

In the image display device according to an aspect of the invention, it is preferable that the emission-direction selecting section be a cylindrical lens.

In the image display device according to an aspect of the invention, it is preferable that the luminous intensity of the small light-emitting section is variable.

For example, when the distance from the pixel in the center of the display surface to the viewer and the distance from the pixel at the end of the display surface to the viewer are different, the image appears to be different in luminance for the viewer because of the different distances, provided that the luminances of the both pixels are the same.

The above-described structure allows the luminous intensity of the small light-emitting sections to be changed, thus providing an image of uniform luminance to the viewer.

In the image display device according to an aspect of the invention, it is preferable that the small light-emitting section be an organic electroluminescence device.

In the image display device according to an aspect of the invention, it is preferable that the relative position of the pixel to the emission-direction selecting section be movable.

This arrangement allows the pixels and the emission-direction selecting sections to be moved relatively. When the pixels and the emission-direction selecting sections are moved relatively, the direction of the light emitted from the small light-emitting sections changes with the moved distance. Thus, with the viewer in the same position, small light-emitting sections that are made luminous change before and after the movement. This prevents excessive use of a specific small light-emitting section to allow using multiple small light-emitting sections, for example, even if the small light-emitting section is a device whose life depends on the amount of light emission. Thus, the life of the small light-emitting sections can be increased.

### BRIEF DESCRIPTION OF THE DRAWINGS

The invention will be described with reference to the accompanying drawings, wherein like numbers reference like elements.

FIG. 1 is a schematic perspective view of an image display device according to a first embodiment of the invention.

FIG. 2 is a schematic enlarged front view of part of the display section of a selfluminous display 1.

FIG. 3 is a diagram illustrating the direction of light emitted from small light-emitting sections.

FIG. 4 is a diagram illustrating the reachable range of light emitted from the small light-emitting sections.

FIG. 5 is a diagram illustrating a method for driving the pixels.

FIG. 6 is a diagram illustrating a concrete method for selectively making only small light-emitting sections that can emit light to the viewer luminous.

FIG. 7 is a diagram illustrating a concrete method for selectively making only small light-emitting sections that can emit light to the viewer luminous.

FIG. 8 is a flowchart of the operation of the image display device according to the first embodiment of the invention.

FIG. 9 is a diagram illustrating the operation of the image display device according to the first embodiment.

FIG. 10 is a diagram illustrating the operation of the image display device according to the first embodiment.

FIG. 11 is a diagram illustrating the operation of a modification of the image display device according to the first embodiment.

FIG. 12 is a diagram illustrating the operation of the modification of the image display device according to the first embodiment.

FIG. 13 is a diagram for describing the operation of the modification of the image display device according to the first embodiment.

FIG. 14 is a schematic enlarged front view of part of the display section of the selfluminous display of an image display device according to a second embodiment of the invention.

### DESCRIPTION OF EXEMPLARY EMBODIMENTS

An image display device according to embodiments of the invention will be described with reference to the drawings. In the following drawings, the scale of the components is changed as appropriate for the convenient of recognition.

### First Embodiment

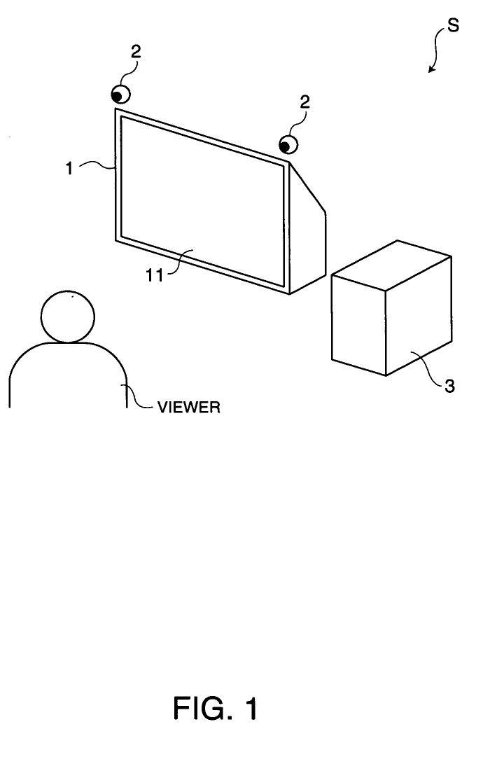

FIG. 1 is a schematic perspective view of an image display device S of a first embodiment. As shown, the image display device S includes a selfluminous display 1, a sensor 2, and a controller 3.

Although FIG. 1 separately shows the selfluminous display 1, the sensor 2, and the controller 3 for the convenience of description, they may be unitary. For example, it is also possible that the controller 3 is housed in the casing of the selfluminous display 1, and that the sensor 2 is supported by the casing of the selfluminous display 1.

The selfluminous display 1 includes a display section 11 having a plurality of selfluminous pixels. In this embodiment, the selfluminous display 1 is a VGA display in which the display section 11 has 480×640 pixels for the convenience of description. However, the invention is not limited to that but other high-resolution displays can be used.

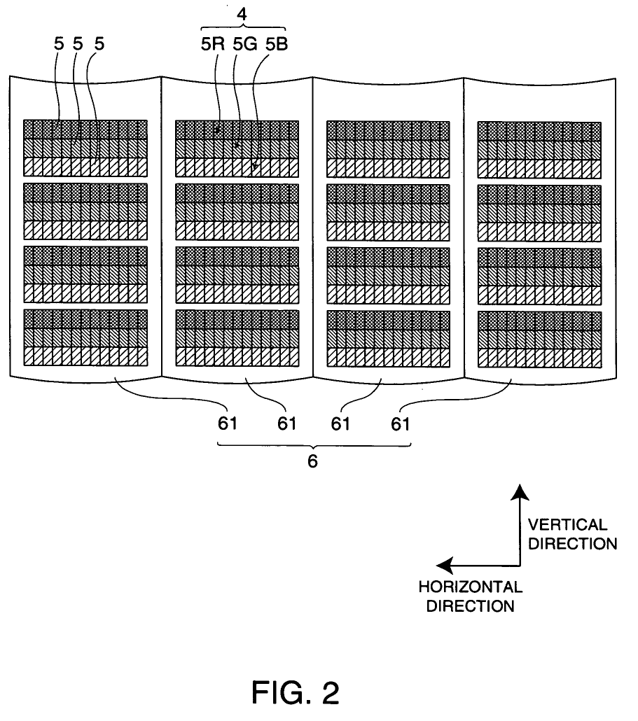

FIG. 2 is a schematic enlarged front view of part of the display section 11 of the selfluminous display 1. Although FIG. 2 shows only a 4×4 matrix of pixels 4, the display section 11 of the selfluminous display 1 (see FIG. 1) actually has a 480×640 matrix of pixels 4. In the image display device S of this embodiment, each of the pixels 4 is divided into a plurality of small light-emitting sections 5, as shown in FIG. 2. The light-emitting section 5 may be an organic EL element having an organic functional layer that is made luminous by the supply of current.

The small light-emitting sections 5 are divided into a red group 5R that emits red light, a green group 5G that emits green light, and a blue group 5B that emits blue light. The red group 5R, the green group 5G, and the blue group 5B are arranged vertically (vertically in FIG. 2) in one pixel. The groups 5R, 5G, and 5B are each composed of 13 small light-emitting sections 5 arranged horizontally (laterally in FIG. 2).

The display section 11 with this structure has a lenticule 6 thereon, as shown in FIG. 2.

The lenticule 6 is such that a plurality of vertical cylindrical lenses 61 (ejection-direction selecting sections) are arranged horizontally. Each cylindrical lens 61 has a width corresponding to the width of each pixel 4, and is disposed so as to cover one column (480 pieces) of pixels 4 per the cylindrical lens 61.

The cylindrical lens 61 angles the light from the small light-emitting sections 5 horizontally according to the horizontal disposition of the small light-emitting sections 5 in the pixel 4.

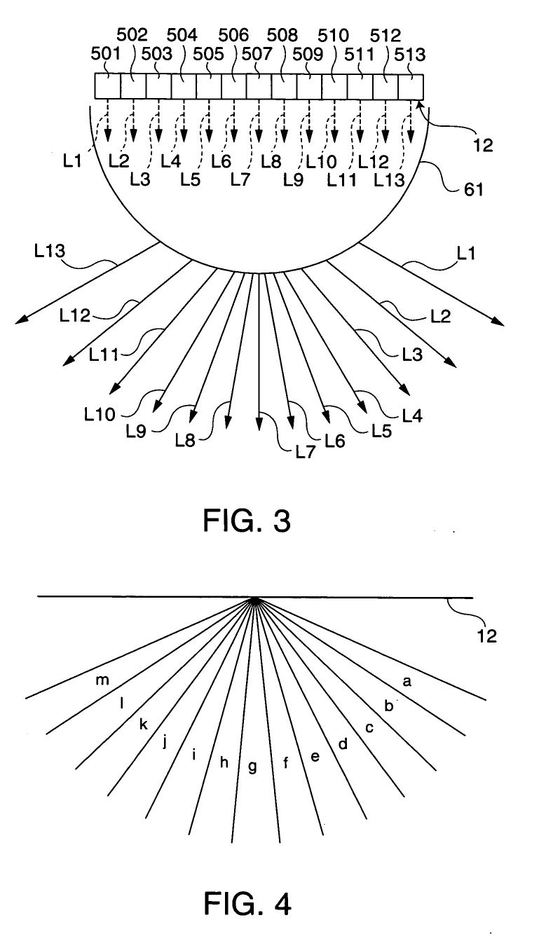

Specifically, as shown in FIG. 3, of the 13 small light-emitting sections 5 of the 320^{th} column in the central, light L1 emitted from the leftmost small light-emitting section 501 is ejected (deflected) counterclockwise to the range from 145 to 155 degrees with respect to a display surface 12 by the cylindrical lens 61. Light L2 emitted from the second small light-emitting section 502 is ejected (deflected) to the range from 135 to 145 degrees with respect to the display surface 12. Light L3 emitted from the third small light-emitting section 503 is ejected (deflected) to the range from 125 to 135 degrees with respect to the display surface 12. Light L4 emitted from the fourth small light-emitting section 504 is ejected (deflected) to the range from 115 to 125 degrees with respect to the display surface 12. Light L5 emitted from the fifth small light-emitting section 505 is ejected (deflected) to the range from 105 to 115 degrees with respect to the display surface 12. Light L6 emitted from the sixth small light-emitting section 506 is ejected (deflected) to the range from 95 to 105 degrees with respect to the display surface 12. Light L7 emitted from the seventh small light-emitting section 507 is ejected (deflected) to the range from 85 to 95 degrees with respect to the display surface 12. Light L8 emitted from the eighth small light-emitting section 508 is ejected (deflected) to the range from 75 to 85 degrees with respect to the display surface 12. Light L9 emitted from the ninth small light-emitting section 509 is ejected (deflected) to the range from 65 to 75 degrees with respect to the display surface 12. Light L10 emitted from the 10^{th} small light-emitting section 510 is ejected (deflected) to the range from 55 to 65 degrees with respect to the display surface 12. Light L11 emitted from the 11^{th} small light-emitting section 511 is ejected (deflected) to the range from 45 to 55 degrees with respect to the display surface 12. Light L12 emitted from the 12^{th} small light-emitting section 512 is ejected (deflected) to the range from 35 to 45 degrees with respect to the display surface 12. Light L13 emitted from the 13^{th} small light-emitting section 513 is ejected (deflected) to the range from 25 to 35 degrees with respect to the display surface 12.

In the image display device S of the embodiment, the pixels 4 having the same structure are arranged in matrix form and the cylindrical lens 61 is disposed in the vertical direction. Accordingly, the lights emitted from the small light-emitting sections 5 in the same column are ejected (deflected) at the same angle. For example, all the lights from the fifth small light-emitting sections 5 from the left in the 300^{th} column pixel 4 from the left of FIG. 2 are ejected (deflected) at the same angle.

This arrangement makes region a a reachable region for light L1, region b a reachable region for light L2, region c a reachable region for light L3, region d a reachable region for light L4, region e a reachable region for light L5, region f a reachable region for light L6, region g a reachable region for light L7, region h a reachable region for light L8, region i a reachable region for light L9, region j a reachable region for light L10, region k a reachable region for light L11, region l a reachable region for light L12, region m a reachable region for light L13, shown in FIG. 4.

In other words, the display section 11 of the image display device S of this embodiment is constructed such that the pixel columns and the cylindrical lens 61 are arranged horizontally.

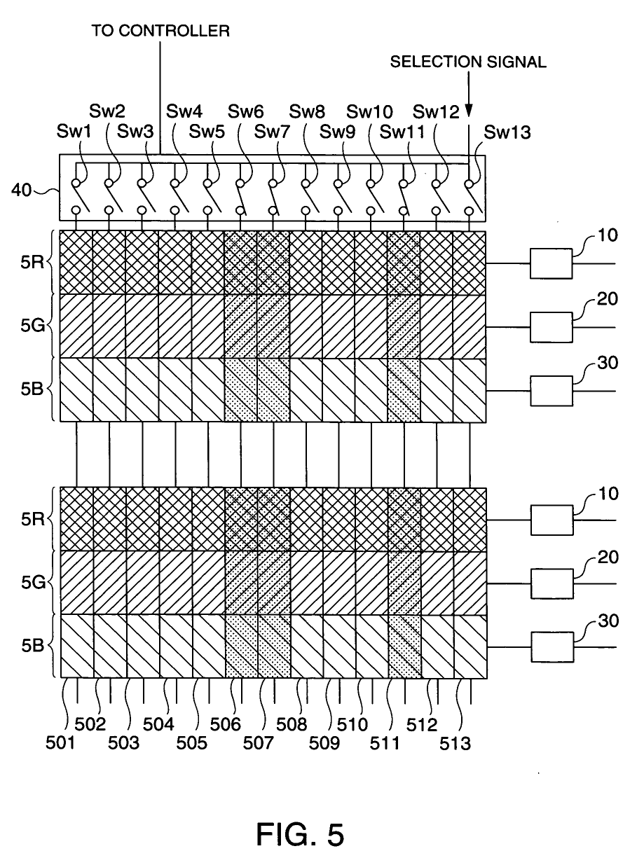

FIG. 5 is an illustration showing a method for driving the pixels 4. As shown, the image display device S of the embodiment includes a drive circuit 10 for supplying an image signal to the red group, a drive circuit 20 for supplying an image signal to the green group, and a drive circuit 30 for supplying an image signal to the blue group every line of the pixel matrix. One drive circuit 10 allows all the red groups in the same line to be supplied with an image signal. One drive circuit 20 allows all the green groups in the same line to be supplied with an image signal. One drive circuit 30 allows all the blue groups in the same line to be supplied with an image signal. The image signals are supplied to the drive circuits 10, 20, and 30 via a driver (not shown).

A selection circuit 40 for supplying a selection signal to each pixel is disposed for each column of the pixel matrix. One selection circuit 40 allows all the pixels 4 in the same column to be supplied with a selection signal. The selection signals are supplied to the selection circuit 40 via a driver (not shown).

The selection circuit 40 has therein switching devices Sw1 to Sw13 for selectively distributing the external selection signals to the small light-emitting sections 5 in the pixel. Turning the switching devices Sw1 to Sw13 on or off allows selection of which column of the small light-emitting sections 5 in the pixels is supplied with the selection signal. When one switching device is turned on, all the small light-emitting sections 5 in the column corresponding to the switching device are supplied with the selection signal. The ON/OFF of the switching devices Sw1 to Sw13 is controlled by the controller 3, to be described later in detail.

In the image display unit S of the embodiment, the pixels 4 in the same column are covered with the vertical cylindrical lens 61. Accordingly, the lights emitted from the small light-emitting sections 5 in the same column travel at the same angle. In other words, the small light-emitting sections 5 that emit light at the same angle are arranged in the same column or along the same straight line. Accordingly, when one of the switching devices Sw1 to Sw13 is turned on, the selection signal is supplied to all the small light-emitting sections 5 that emit light at the same angle. Thus, in the image display device S of the embodiment, the plurality of small light-emitting sections 5 arranged along the same straight line can be connected with the same line, and can be controlled by one switching device. This arrangement simplifies the controller.

The image display device S of the embodiment is constructed such that when both an image signal and a selection signal are supplied, the small light-emitting sections 5 emits light.

The sensor 2 outputs a signal including the positional information on the viewer, and constitutes part of a viewer position detector of the embodiment of the invention. The sensor 2 may be an infrared sensor, a camera, or a marker sensor which senses a marker attached to the viewer.

The controller 3 has both the function of calculating the position of the viewer (detection result) on the basis of a signal input from the sensor 2 and the function of selectively making only a small light-emitting section 5 that can surely emit light to the viewer luminous on the basis of the viewer's position. That is, the controller 3 constitutes part of the viewer position detector and the controller of the embodiment of the invention. The viewer position detector is configured by the sensor 2 and the controller 3.

An example of a concrete method for selectively making only a small light-emitting section 5 that surely emits light to the viewer luminous.

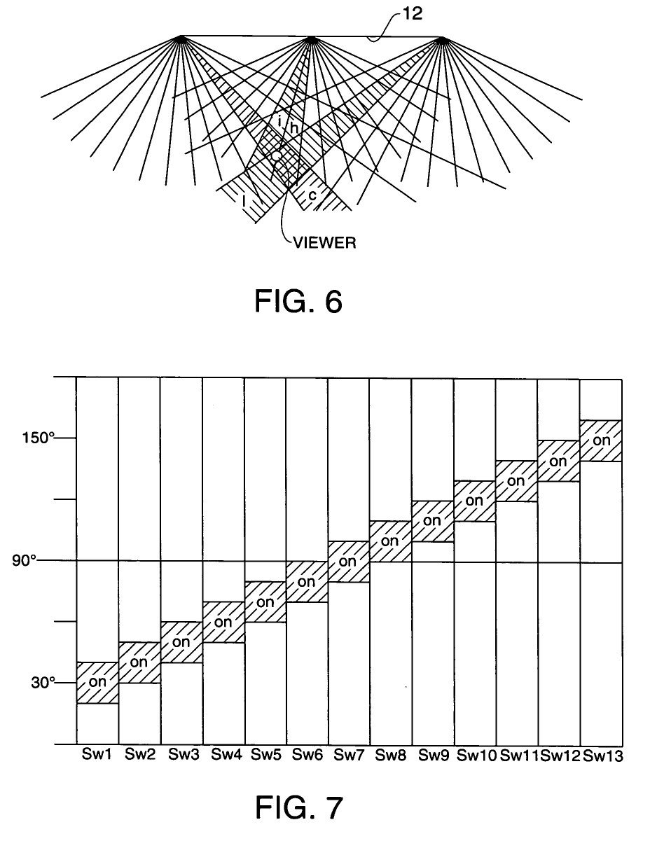

For example, when the viewer is at the position shown in FIG. 6, for the leftmost pixel column (the first column) of the display section 11, the viewer is in the range in which the light from the third small light-emitting section 503 can reach. For the pixel column (the 320^{th} column) in the center of the display section 11, the viewer is in the range in which the light from the eighth small light-emitting section 508 and the light from the ninth small light-emitting section 509 can reach. For the rightmost pixel column (the 640^{th} column) of the display section 11, the viewer is in the range in which the light from the 12^{th} small light-emitting section 512 can reach.

Accordingly, in order to provide an image to the viewer who is in the position shown in FIG. 6, it is preferable that the third small light-emitting section 503 in the leftmost pixel column, the eighth and ninth small light-emitting sections 508 and 509 in the center pixel column, and the 12^{th} small light-emitting section 512 in the rightmost pixel column are made luminous.

Accordingly, it is preferable that, of the switching devices Sw1 to Sw13 for the leftmost pixel column, the switching device Sw3 corresponding to the small light-emitting section 503 be turned on by the controller 3; of the switching devices Sw1 to Sw13 for the central pixel column, the switching device Sw8 and Sw9 corresponding to the small light-emitting sections 508 and 509 be turned on by the controller 3; of the switching devices Sw1 to Sw13 for the rightmost pixel column, the switching device Sw12 corresponding to the small light-emitting section 512 be turned on by the controller 3; and the small light-emitting sections 503, 508, 509, and 512 be supplied with image signals.

Here, the viewer shown in FIG. 6 is located at angle θa with respect to the leftmost pixel column, at angle θb with respect to the central pixel column, and angle θc with respect to the rightmost pixel column.

Since the angles θa to θc can be calculated from signals input from the sensor 2, it is desirable that the controller 3 store a look-up table (LUT) or a function in which the angle θa and the switching device Sw3 are associated with each other for the leftmost pixel column, store an LUT or a function in which the angle θb and the switching devices Sw8 and Sw9 are associated with each other for the central pixel column, and store an LUT or a function in which the angle θc and the switching device Sw12 are associated with each other for the rightmost pixel column.

Specifically, it is desirable that the controller 3 store the ON/OFF information (luminous-position information) of the switching devices associated with angles, as shown in FIG. 7.

In practice, the luminous-position information associated with angles, as shown in FIG. 7, is required for all the pixel columns.

Therefore, the luminous-position information associated with angles is stored in the controller 3 as an LUT or a function for each pixel column. Then the angle of the viewer with respect to each pixel column is calculated from the viewer's position, and then luminous-position information associated with the calculated angles is acquired. The ON/OFF of the switching devices Sw1 to Sw13 provided for corresponding pixel columns is controlled on the basis of the acquired luminous-position information, so that only small light-emitting sections 5 capable of surely emitting light to the viewer can be made luminous selectively.

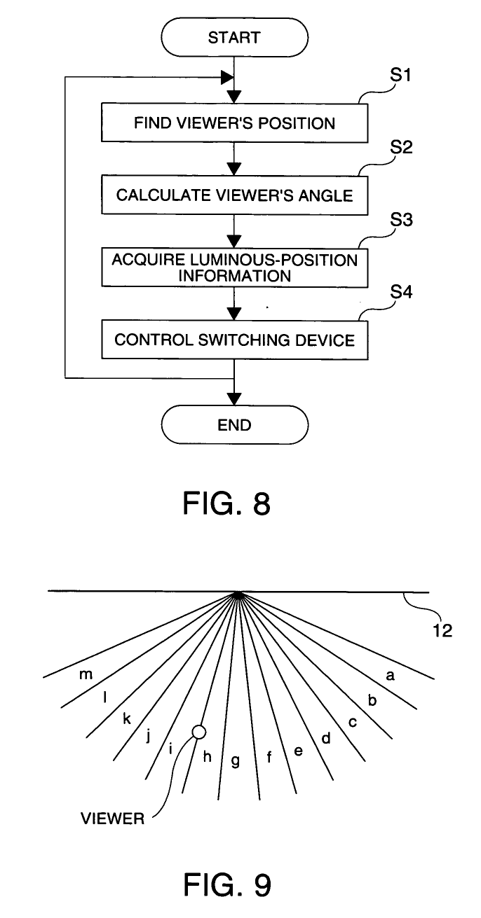

Referring next to the flowchart of FIG. 8, the operation of the image display device S of the embodiment with such a structure will be described.

As shown in FIG. 8, the image display device S of the embodiment first finds a viewer's position (step S1).

Specifically, the controller 3 calculates the position coordinates of the viewer on the basis of the signal input from the sensor 2. In this embodiment, the controller 3 finds the position coordinate P (xₚ, zₚ) of the viewer (viewer-position information indicative of the viewer's position) where the leftmost pixel column as seen from the viewer is the origin, the direction of the normal of the display surface 12 is the z-direction, and the right seen from the viewer is the x-direction.

Subsequently, the controller 3 calculates the angle of the viewer relative to the pixel columns from the position coordinates of the viewer (step S2).

Specifically, the controller 3 calculates the angle θk of the viewer with respect to the k^{th} pixel column by Eq. (1) using the position coordinates P (xₚ, zₚ) of the viewer as follows:
tan θk=zₚ/(xₚ−dk) (1)
where d is the width of the pixel column.

The use of Eq. (1) allows the controller 3 to calculate the angle of the viewer relative to all the pixel columns.

Then, the controller 3 acquires the luminous-position information on the ON/OFF of the switching devices associated with angles for each pixel column on the basis of the angle of the viewer relative to each pixel column which is calculated in step S2 (step S3).

Specifically, the controller 3 acquires luminous-position information (see FIG. 7) of each pixel column in association with angles, which is stored as an LUT or a function.

For example, when the angle of the viewer relative to the leftmost pixel column (the first column) is 40 degrees, the controller 3 acquires luminous-position information instructing to turn on the switching device Sw3 from the relational chart of FIG. 7.

When the angle of the viewer relative to the central pixel column (the 320^{th} column) is 125 degrees, the controller 3 acquires luminous-position information instructing to turn on the switching devices Sw8 and Sw9 from the relational chart of FIG. 7.

When the angle of the viewer relative to the rightmost pixel column (the 640^{th} column) is 140 degrees, the controller 3 acquires luminous-position information instructing to turn on the switching device Sw12 from the relational chart of FIG. 7.

Then the controller 3 supplies the luminous-position information per pixel column that is acquired in step S3 to the selection circuit 40 disposed for each pixel column to thereby control the ON/OFF of the switching devices Sw1 to Sw13 in each selection circuit 40 (step S4).

Thus, only small light-emitting sections 5 that emit light reachable to the viewer are made luminous. Although all small light-emitting sections 5 that emit light reachable to the viewer are made luminous, only those supplied with the image signals from the drive circuits 10, 20, and 30 are actually made luminous.

When the steps S1 to S4 end, the controller 3 returns to step S1, where it updates the position coordinates of the viewer.

According to the embodiment, the angles of the viewer relative to all the pixel columns are calculated in step S2; luminous-position information is acquired for all the pixel columns in step S3; and the ON/OFF of the switching devices Sw1 to Sw13 in all the selection circuits 40 is controlled in step S4. However, the invention is not limited to that but may be constructed such that after the process of steps S2 to S4 has been performed for one pixel column, then the process of steps S2 to S4 is performed for the different pixel columns, and upon completion of steps S2 to S4 for all the pixel columns, the procedure may be returned to step S1.

When there are one or more viewers, the position coordinates of the viewers are acquired in step S1, and then steps S2 to S4 are performed for the position coordinates.

The image display device S of the embodiment is constructed such that one pixel 4 is divided into a plurality of small light-emitting sections 5, and the lights from the light-emitting sections 5 are directed at specified angles according to the position of the light-emitting sections 5 in the pixel 4. The position of the viewer is detected, and on the basis of the detection result, only small light-emitting sections 5 that can surely emit light to the viewer are made luminous selectively.

In other words, the image display device S of the embodiment eliminates the need for emitting useless light that does not reach the viewer as in the known image display device. This arrangement can greatly reduce the light emission of the entire system in comparison with the known image display device. Therefore, the image display device S of the embodiment can reduce the power consumption of the selfluminous display.

The image display device S of the embodiment is constructed such that the small light-emitting sections 5 are divided into the red group 5R that emits red light, the green group 5G that emits green light, and the blue group 5B that emits blue light. The light from any one of the light-emitting sections 5 of the groups can reach the viewer. Thus, the image display device S can provide a full color image to the viewer present in any position.

The image display device S of the embodiment is constructed such that the groups 5R, 5G, and 5B each have 13 small light-emitting sections 5. This arrangement can more efficiently decrease the light emission of one pixel in comparison with that of the known image display device, thus decreasing the power consumption of selfluminous displays.

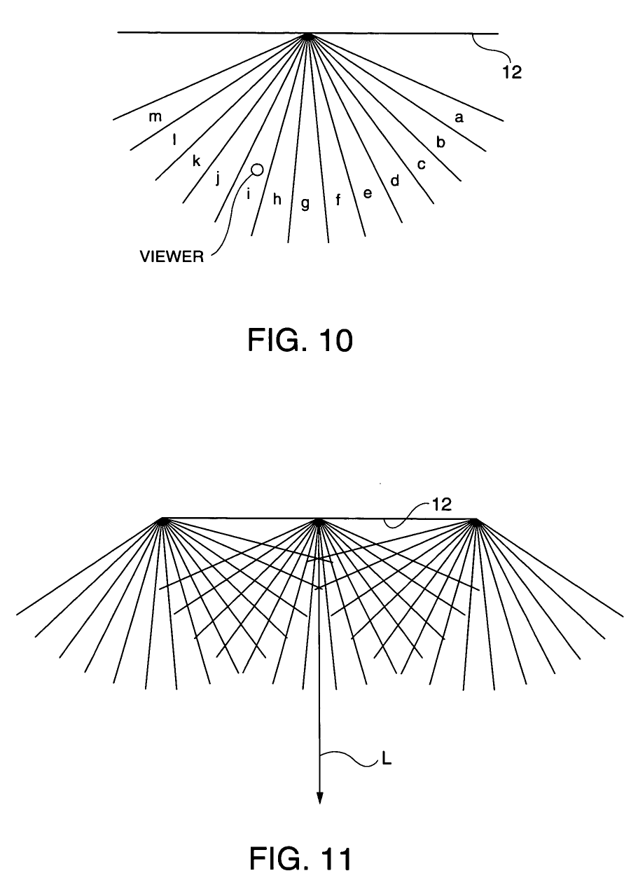

In the image display device S of the embodiment, when the viewer moves, that is, when the viewer changes in position during viewing, the image display device S changes from a state in which the lights from both of adjacent small light-emitting sections 5 in the same group can reach the viewer (both light-emitting sections 5 emit light), as shown in FIG. 9, to a state in which the light from one of the adjacent small light-emitting sections 5 in the same group can reach the viewer (only one light-emitting section 5 emit light), as shown in FIG. 10, and vice versa.

A large difference between the luminance of the former case and the luminance of the latter case may cause flickering. Accordingly, it is preferable to limit the difference between the luminance of the aforementioned state and that of the after-mentioned state within 50 percent. This prevents unpleasantness of the viewer due to changes in luminance.

In the image display device S of the embodiment of the invention, the viewable range is a range that the light from all the pixels 4 can reach. Specifically, even if the light from the pixel 4 at the end of the display surface 12 can reach outside the range that the light from the pixel 4 in the center of the display surface 12 reaches, the light from the pixel 4 in the center of the display surface 12 cannot reach the region, so that the light comes to waste.

Accordingly, the light from the small light-emitting sections 5 can be concentrated efficiently within the range that the light from the pixel 4 in the center of the display surface 12 reaches by allowing the small light-emitting sections to emit the light closer to the central axis L (the normal in the center of the display surface) as the small light-emitting section is located closer to the end of the display surface 12, as shown in FIG. 11, thereby allowing covering of the viewable range without waste.

Specifically, the light from the small light-emitting sections 5 can be closer to the central axis L of the display surface 12 as the small light-emitting section is located closer to the end of the display surface 12 by changing the shape of the cylindrical lenses 61.

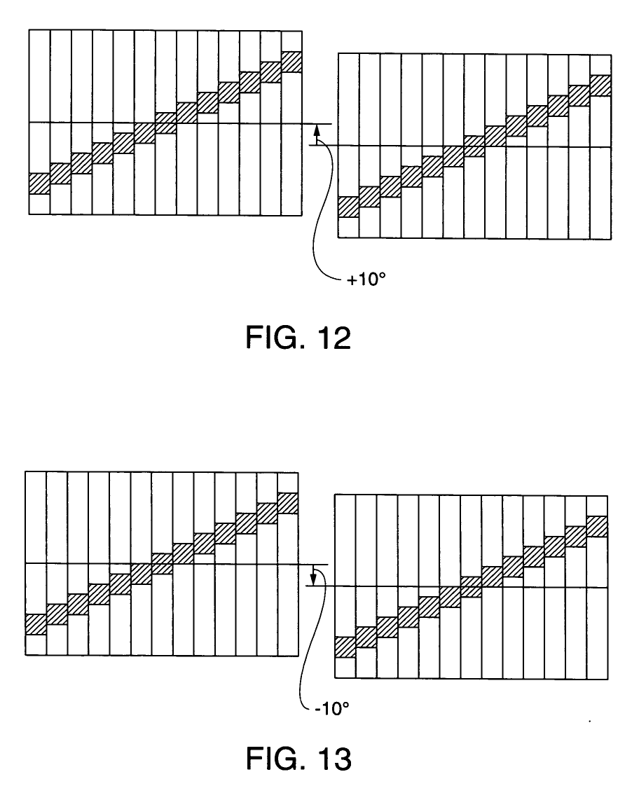

When the light from the small light-emitting sections 5 closer to the end of the display surface 12 is emitted closer to the central axis L of the display surface 12, the reachable range of the light from the small light-emitting sections 5 at the ends may goes out of the range. Thus, the LUT or the function stored in advance in the controller 3 needs to have an offset. For example, when the light emitted from the leftmost pixel column (the first column) of the display surface 12 is angled at +10 degrees toward the central axis L, it is necessary to store an LUT or a function that is offset by +10 degrees from the LUT or the function stored for the pixel column (the 320^{th} column) in the center of the display surface 12, as shown in FIG. 12, for the leftmost pixel column (the first column) of the display surface 12. When the light emitted from the rightmost pixel column (the 640^{th} column) of the display surface 12 is angled at −10 degrees toward the central axis L, it is necessary to store an LUT or a function that is offset by −10 degrees from the LUT or the function stored for the pixel column (the 320^{th} column) in the center of the display surface 12, as shown in FIG. 13, for the rightmost pixel column (the 640^{th} column) of the display surface 12.

### Second Embodiment

A second embodiment of the invention will next be described. In the second embodiment, the description of parts similar to those described in the first embodiment is omitted or simplified.

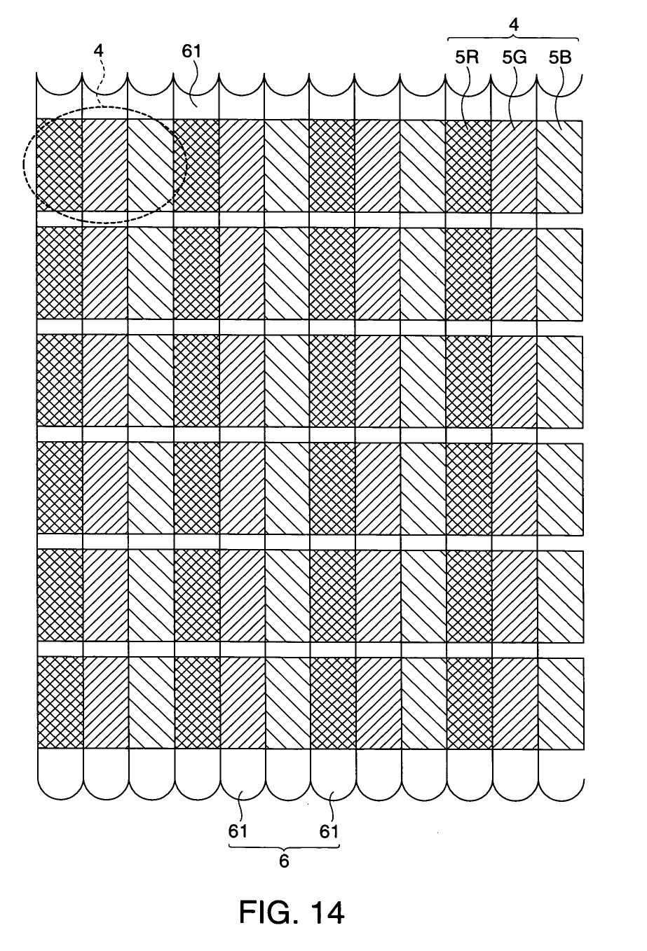

FIG. 14 is a schematic enlarged front view of part of the display section 11 of the selfluminous display 1 according to the second embodiment. Although FIG. 14 shows only a 6×4 matrix of pixels 4, the display section 11 of the selfluminous display 1 actually has a 480 by 640 matrix of pixels 4.

In the image display device of this embodiment also, each of the pixels 4 is divided into a plurality of small light-emitting sections 5. The small light-emitting sections 5 are divided into a red group 5R that emits red light, a green group 5G that emits green light, and a blue group 5B that emits blue light. The red group 5R, the green group 5G, and the blue group 5B are arranged horizontally in one pixel. The groups 5R, 5G, and 5B of the image display device of this embodiment are each composed of 13 small light-emitting sections 5 arranged horizontally, like the image display device of the first embodiment.

In the image display device of this embodiment, the cylindrical lenses 61 are provided not for each pixel column but for each group column. The selection circuit 40 is provided for each group column.

The arrangement of the image display device allows group-by-group control of the light emission of the small light-emitting sections 5. Moreover, each group is covered with the cylindrical lens 61.

For example, when the viewer is present in a position where the light from two adjacent small light-emitting sections can reach, the image display device of the first embodiment needs to make six small light-emitting sections luminous. In contrast, in the second embodiment, there is a subtle difference in direction among the lights emitted from the red group, the green group, and the blue group. Accordingly, the lights from two adjacent small light-emitting sections of all the groups do not reach the viewer, so that the number of the small light-emitting sections that are made luminous can be decreased.

In the image display device of this embodiment, the cylindrical lens 61 is disposed for each group that emits the same color light. This allows forming the cylindrical lens 61 according to the color of luminescent light, thus decreasing the influence of chromatic aberration.

Although the image display device of the embodiment of the invention has been described in its preferred embodiments with reference to the accompanying drawings, it is to be understood that the invention is not limited to those. The shapes and combinations of the components shown in the foregoing embodiments are only examples and various modifications may be made in the invention according to design requirements without departing from the spirit and scope of the invention.

For example, in the foregoing embodiments, only the ON/OFF of the small light-emitting sections 5 is controlled. However, the invention is not limited to that. Alternatively, the luminous intensity of the small light-emitting sections 5 may be controlled by changing the resistance of a variable resistor, in place of the switching devices.

The image display device of the embodiments may be constructed such that the lenticule 6 can be moved horizontally on the display surface 12. When the lenticule 6 is moved on the display surface 12, the direction of the light emitted from the small light-emitting sections changes with the moved distance of the lenticule 6. Thus, when the viewer is in the same position, small light-emitting sections that are made luminous change before and after the movement. Accordingly, for example, even when the small light-emitting section is an organic EL device whose life depends on the amount of light emission, this arrangement prevents excessive use of a specific small light-emitting section to allow using multiple small light-emitting sections, thus increasing the life of the small light-emitting sections. In addition, it is preferable to increase the number of the pixel columns of the display section 11 by at least one when the lenticule 6 is horizontally movable.

In the image display device of the embodiments, since emitted light is directed only in the horizontal direction, the lenticule is used as means for selecting the direction of the light. Alternatively, the invention may be constructed such that a microlens is disposed for each pixel as means for selecting the direction of the light, and the small light-emitting sections are arranged horizontally and vertically in the pixel so that emitted light is directed horizontally and vertically.

The invention may provide information to the viewer by displaying the degree of power consumption or energy conservation depending on the number of luminous small light-emitting sections 5.

The embodiments are constructed such that the controller 3 calculates the position coordinates of the viewer on the basis of signals input from the sensor 2 to find the position coordinates P(xₚ, zₚ). However, the invention is not limited to that; for example, a remote controller to be operated by the viewer is provided and the position coordinates P(xₚ, zₚ) may be found from the input from the remote controller. For example, when the distance of the viewer from the display surface 12 is fixed, only the coordinate P(xₚ) may be found from the input of the remote control, with the coordinate P(zₚ) fixed.

When the position of the viewer is uniquely defined by the seat as in a theater, it is also possible to store a table in advance in which the seat and the position coordinates P (xₚ, zₚ) are associated with each other, from which the position coordinates P (xₚ, zₚ) may be obtained.

The entire disclosure of Japanese Patent Application No. 2005-348954, filed Dec. 2, 2005 is expressly incorporated by reference.

What is claimed is:

1. An image display device having a plurality of selfluminous pixels, for displaying an image by selectively making the pixels luminous, the image display device comprising:
the pixels each divided into a plurality of small light-emitting sections;
an ejection-direction selecting section that ejects the light emitted from the small light-emitting sections at predetermined angles according to the position of the small light-emitting sections in the pixel; and
a controller that selectively makes only small light-emitting sections that emit light that can reach the viewer luminous on the basis of viewer-position information indicative of the position of the viewer.

2. An image display device comprising a viewer-position sensor that acquires the viewer-position information.

3. The image display device according to claim 1, wherein:
the plurality of small light-emitting sections are divided into a plurality of groups which can emit the light in different colors; and
the luminescent light of any one of the small light-emitting sections of each group can reach the viewer who is present in a predetermined position.

4. The image display device according to claim 3, wherein the groups each have at least five small light-emitting sections.

5. The image display device according to claim 3, wherein the plurality of groups is arranged in the vertical direction in the pixel.

6. The image display device according to claim 3, wherein the plurality of groups are arranged in the horizontal direction in the pixel.

7. The image display device according to claim 3, wherein:
the difference between the luminance in the case where the luminescent lights of both adjacent small light-emitting sections in the same group reach the viewer who is in a predetermined place and the luminance in the case where the luminescent light of any one of adjacent small light-emitting sections in the same group reaches the viewer who is in a predetermined place is set within 50 percent.

8. The image display device according to claim 1, wherein at least part of the small light-emitting sections that can emit light to the viewer who is present in a predetermined position is arranged along the same straight line.

9. The image display device according to claim 1, wherein the emission-direction selecting section ejects the light emitted from the small light-emitting section closer to the central axis of the display surface as the small light-emitting section is located closer to the end of the image display surface.

10. The image display device according to claim 1, wherein the emission-direction selecting section is a cylindrical lens.

11. The image display device according to claim 1, wherein the luminous intensity of the small light-emitting section is variable.

12. The image display device according to claim 1, wherein the small light-emitting section is an organic electroluminescence device.

13. The image display device according to claim 1 wherein the relative position of the pixel to the emission-direction selecting section is movable.
